(19) United States
(12) Patent Application Publication
(10) Pub. No.: US 2026/0298312 A1
(43) Pub. Date: Oct. 1, 2026

(54) Multi-Purpose Hanging Buckle Apparatus

(71) Applicant: BINOVO MANUFACTURING CO., LTD, Yangjiang (CN)

(72) Inventors: Liangbin LING, Yangjiang (CN); Pang LIANG, Yangjiang (CN); Houkun LIANG, Yangjiang (CN)

(21) Appl. No.: 19/090,686

(22) Filed: Mar. 26, 2025

(51) Int. Cl. F16G 11/14; F16M 13/02

(52) U.S. Cl. CPC F16G 11/143; F16M 13/02

(57) ABSTRACT

The disclosure relates to the technical field of hanging buckles, in particular to a multi-purpose hanging buckle apparatus. The multi-purpose hanging buckle apparatus includes at least one hanging buckle group and at least one flexible hanging rope, and the at least one flexible hanging rope is sequentially connected with the at least one hanging buckle group in a penetrating manner; and the hanging buckle group includes a hanging buckle body with an opening and closing function and a connector, the flexible hanging rope is disposed on the connector in a penetrating manner, and the connector and the hanging buckle body are detachably connected.

### TECHNICAL FIELD

The disclosure relates to the technical field of hanging buckles, in particular to a multi-purpose hanging buckle apparatus.

### BACKGROUND

Hard hanging buckles which are mostly used in the market are in direct hard contact with a hung article when used for hanging the article, so friction is caused, abnormal sound is easily generated, and the article is damaged; and meanwhile, the hanging buckle is fixed in size and not flexible enough, so as not to be suitable for different use occasions and not to meet different demands of customers. For an existing hanging buckle formed by a hard material and a flexible material on the market, the flexible material cannot be replaced, meanwhile, the problems that a use mode is single and the size is fixed also exist, the use range is extremely limited, and thus use demands of customers also cannot be met.

### SUMMARY

In order to solve the problem that an existing hanging buckle is single in use mode and fixed in size, so that the use range is small, and diversified requirements of users cannot be met, the disclosure provides a multi-purpose hanging buckle apparatus which is flexible, meanwhile, the length or number of the hanging buckle is adjusted according to different requirements, so that the use occasion of the hanging buckle is increased, and different demands of users are met.

In order to achieve the above purpose, the disclosure adopts the following technical solution.

A multi-purpose hanging buckle apparatus includes at least one hanging buckle group and at least one flexible hanging rope, and the at least one flexible hanging rope is sequentially connected with the at least one hanging buckle group in a penetrating manner; and each of the at least one hanging buckle group includes a hanging buckle body with an opening and closing function and a connector, each of the at least one flexible hanging rope is disposed on connector of the at least one hanging buckle group in a penetrating manner, and the connector and the hanging buckle body are detachably connected.

In the above solution, according to different applicable occasions and different demands of users, the number of the hanging buckle group and the number of the flexible hanging rope are selected, and they are flexibly connected and combined to obtain different hanging buckle apparatuses; for example, through combination of a plurality of hanging buckle groups and one flexible hanging rope, the hanging buckle apparatus can have a plurality of hanging and buckling points; for example, through combination of one hanging buckle group and a plurality of flexible hanging ropes, the hanging buckle apparatus can have a plurality of hanging points; still for example, through combination of a plurality of hanging buckle groups and a plurality of flexible hanging ropes, the hanging buckle apparatus can have a plurality of hanging and buckling points and a plurality of hanging points at the same time; and random selection is carried out according to demands of users, and the use is extremely convenient. On one hand, the flexible hanging rope is configured for connecting the plurality of hanging buckle groups in a penetrating manner, on the other hand, the flexible hanging rope directly acts on a hung article for being connected with the hung article, and the hanging buckle group serves as the other end of the hanging buckle apparatus for fixing to hang the hung article to a place. Specifically, the hanging buckle body with an opening and closing function is easily hung and fixed, the connector serving as connection and transition of the hanging buckle body and the flexible hanging rope is configured to connect the flexible hanging rope and also is detachably connected with the hanging buckle body, with the detachable connection mode, the flexible hanging rope is conveniently replaced when the flexible hanging rope is worn, and thus the service life of the hanging buckle apparatus is prolonged.

In some embodiments, the hanging buckle body includes a fixed part and a movable part, the fixed part is of a hollow structure with an opening, the movable part blocks the opening, one end of the movable part is hinged with one end of the opening of the fixed part, an other end of the movable part is abutted to or clamped with an other end of the opening of the fixed part, the fixed part is further in threaded connection with the connector, and the movable part is rotated to open or close the opening. The fixed part is configured to bear pull force of hanging and connect the hanging buckle apparatus with outside, so as to realize the hanging function of the hanging buckle apparatus; the movable part is configured to control the opening, by controlling the opening and closing of the opening of the hanging buckle body, the opening is open when the hanging buckle body needs to realize hanging or release hanging with outside, and the purpose is realized; and in a normal hanging process, the opening is closed to avoid separation of the hanging buckle body, so that the hanging reliability of the hanging buckle body is improved. Specifically, through hinging of the movable part with the fixed part, when the movable part is pressed, the movable part can rotate relative to the fixed part, so that the opening is opened or closed. The fixed part is in threaded connection with the connector, so that the fixed part is conveniently detached from the connector, and then assembly and disassembly of the flexible hanging rope are facilitated.

In some embodiments, the movable part has a through hole with a variable cross section, an end part of the fixed part is provided with a clamping block, and the clamping block is clamped with the through hole. The through hole with a variable cross section refers to that cross-sectional areas of the through hole are different at different positions. In some embodiments, the cross-sectional area, of the end where the movable part is close to the clamping block, of the through hole is large, and the cross-sectional area, of the end where the movable part is away from the clamping block, of the through hole is small; and therefore, after the clamping block is clamped with the through hole, the possibility that the clamping block separates from the through hole non-artificially is reduced. Of course, within the cognition range of those skilled in the art, the through hole can also be a through hole with a fixed cross section.

In some embodiments, the connector has at least one threading hole for the flexible hanging rope to pass through. The arrangement of the threading hole can facilitate passing of the flexible hanging rope. One connector can have one or more threading holes, so that one or more flexible hanging ropes can pass through, and thus different functions of the hanging buckle apparatus are realized.

In some embodiments, two threading holes are available, and the flexible hanging rope is disposed in a manner of passing through the two threading holes respectively. When a plurality of hanging buckle groups and one flexible hanging rope are available, after passing through one threading hole, the flexible hanging rope can pass out from the other threading hole, so that the flexible hanging rope forms penetration connection with the connector, and then the flexible hanging rope completes sequential penetration connection with each hanging buckle group; when only one hanging buckle group and one flexible hanging rope are available, two ends of the flexible hanging rope are respectively placed on the side, connected with the hanging buckle body, of the connector, two ends of the flexible hanging rope are knotted, furthermore, the flexible hanging rope can also be sintered to improve reliability of connection, so that the flexible hanging rope is stably connected with the connector in a penetrating manner, and meanwhile, when the flexible hanging rope is connected with a hung article, fall and separation from the connector due to force can also be avoided; when the flexible hanging rope needs to be replaced, the knotting position is untied or sheared off, in such a case, the flexible hanging rope is pulled out from the other side of the threading hole; and the part of the flexible hanging rope located on the other side of the connector forms a closed structure together with the connector, so that the flexible hanging rope is conveniently connected with the hung article. Of course, according to needs of use, if the flexible hanging rope at a free end is more suitable for connection of the hung article, the positions of the flexible hanging rope and the connector can also be adjusted, so that two free ends of the flexible hanging rope are located on a side of the connector away from the hanging buckle body, the part of the flexible hanging rope located on one side of the connector close to the hanging fastener body forms a closed structure together with the connector, in such a case, two free ends of the flexible hanging rope are utilized to be connected with the hung article, but the connection reliability of the flexible hanging rope and the hung article needs to be ensured to ensure the reliability of the whole hanging buckle apparatus. When a plurality of flexible hanging ropes are available, the size of the threading hole is correspondingly designed, and the plurality of flexible hanging ropes can pass through the same threading hole, so that the need of hanging an article of the hanging buckle apparatus is met.

In some embodiments, one hanging buckle group is available, and one flexible hanging rope is available. The hanging buckle group is utilized for hanging to outside, the flexible hanging rope is utilized for connection with the hung article, and the flexible hanging rope is fixed and hung on carriers of different shapes through tying.

In some embodiments, one hanging buckle group is available, and 2-6 flexible hanging ropes are available. The plurality of flexible hanging ropes are connected with the same hanging buckle group in a penetrating manner, the hanging buckle group is utilized for hanging with outside, the flexible hanging rope is utilized for connection with the hung article, it is that one flexible hanging rope is adopted for hanging one article, or a plurality of flexible hanging ropes are utilized to act on the same article together, so that the function of the hanging buckle apparatus is realized.

In some embodiments, two hanging buckle groups are available, 1-6 flexible hanging ropes are available, and the two hanging buckle groups are respectively located at two ends of the 1-6 flexible hanging ropes. Two hanging buckle groups are disposed at two ends, the hanging buckle groups at two ends are utilized for hanging with outside, so that a structure similar to a clothesline is formed, and the middle of the flexible hanging rope is connected with the hung article.

In some embodiments, at least three hanging buckle groups are available, and 1-6 flexible hanging ropes are available. One flexible hanging rope is used for connecting each hanging buckle group in a penetrating manner, the length of the flexible hanging rope is correspondingly selected according to needs, and the hanging buckle group is configured for hanging with outside, and also is configured for hanging with the hung article. Or a plurality of flexible hanging ropes are used for sequential penetration connection with each hanging buckle group, so that the strength of the whole hanging buckle apparatus is improved.

In some embodiments, after penetration connection with the hanging buckle group, the flexible hanging rope is formed a closed structure with the hanging buckle group. With the arrangement, the connection of the flexible hanging rope to the hung article is facilitated.

Compared with the art known to inventors, the disclosure has the following beneficial effects.
a. The flexible hanging rope can adopt a composite material, the diversity of its shape is realized by a flexible material, which facilitates match with the shape of the hung article, so as to promote convenience of connection.
b. By assembling and disassembling the connector, match with flexible ropes of different specifications is completed, through position adjustment at double threading holes of the connector, a hanging strap buckle is formed, and the number is increased or decreased or arrangement density is adjusted flexibly.
c. The flexible hanging rope is fixed and hung on carriers of different shapes by tying through the connector, and the use universality is wider.
d. According to needs of use, the size, specification and material of the flexible hanging rope is flexibly replaced, and the flexible hanging rope passes through holes of the connector to realize increase of the number of the hanging buckle, so as to achieve different purposes.

### BRIEF DESCRIPTION OF THE DRAWINGS

FIG. 1 is a structure diagram of Embodiment 1of a multi-purpose hanging buckle apparatus of the disclosure in a first direction.

FIG. 2 is a structure diagram of Embodiment 1 of a multi-purpose hanging buckle apparatus of the disclosure in a second direction.

FIG. 3 is a structure diagram of a sectional view of Embodiment 1 of a multi-purpose hanging buckle apparatus of the disclosure.

FIG. 4 is a structure diagram of an exploded view of Embodiment 1 of a multi-purpose hanging buckle apparatus of the disclosure.

FIG. 5 is a schematic diagram of use of Embodiment 1 of a multi-purpose hanging buckle apparatus of the disclosure.

FIG. 6 is a structure diagram of Embodiment 4 of a multi-purpose hanging buckle apparatus of the disclosure.

FIG. 7 is a structure diagram of a first solution of Embodiment 5 of a multi-purpose hanging buckle apparatus of the disclosure.

FIG. 8 is a structure diagram of a second solution of Embodiment 5 of a multi-purpose hanging buckle apparatus of the disclosure.

FIG. 9 is a structure diagram of a third solution of Embodiment 5 of a multi-purpose hanging buckle apparatus of the disclosure.

a. Hanging buckle group; 11. Hanging buckle body; 111. Fixed part; 1111. Clamping block; 112. Movable part; 1121. Through hole; 12. Connector; 121. Threading hole; and 2. Flexible hanging rope.

### DETAILED DESCRIPTION OF THE EMBODIMENTS

The drawings are for illustrative purposes only and are not to be construed as limiting the disclosure; for the purpose of better illustrating the embodiments, certain parts of the drawings are omitted, enlarged or reduced, which does not represent the size of an actual product; and it will be understood by those skilled in the art that certain well-known structures in the drawings and descriptions thereof are omitted. The positional relationships described in the drawings are for illustrative purposes only and should not be construed as limiting the disclosure.

Same or similar reference numerals in the drawings of the embodiments of the disclosure correspond to same or similar parts. In the description of the disclosure, it is to be understood that orientation or position relationships indicated by terms “upper”, “lower”, “left”, “right”, “long”, “short”, and the like are orientation or position relationships shown in the drawings, are adopted not to indicate or imply that indicated devices or components must be in specific orientations or structured and operated in specific orientations but only to conveniently and simply describe the disclosure, thus the terms for describing positional relationships in the drawings are for illustrative purposes only and should not be understood as limits to the disclosure, and for those of ordinary skill in the art, specific meanings of the above terms can be understood according to a specific condition.

The technical solutions of the disclosure will be further described in detail below through specific embodiments with reference to drawings.

### Embodiment 1

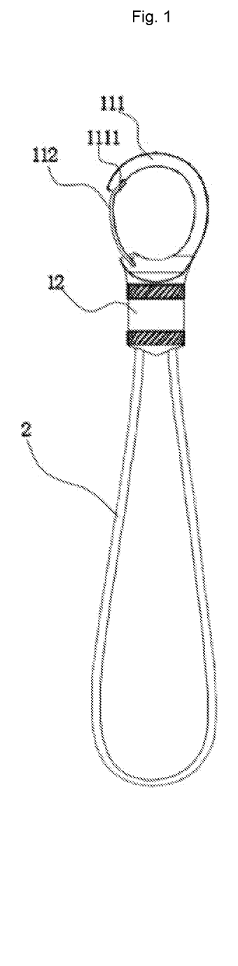

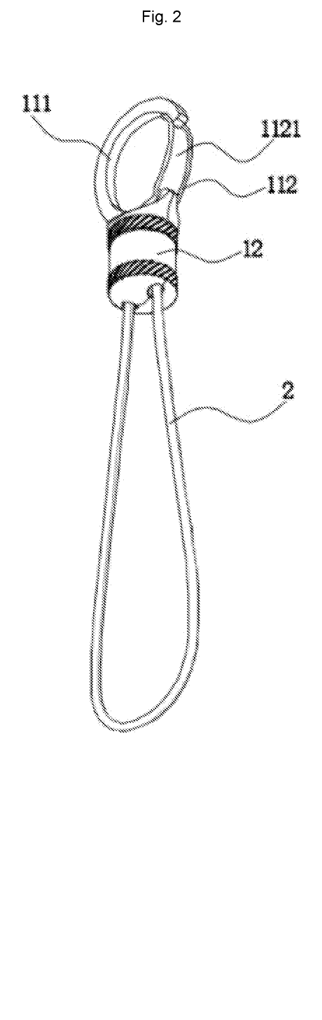

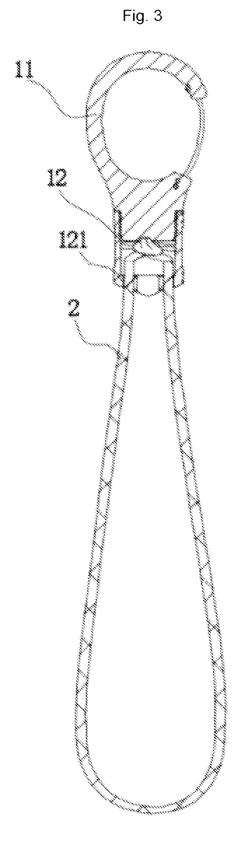

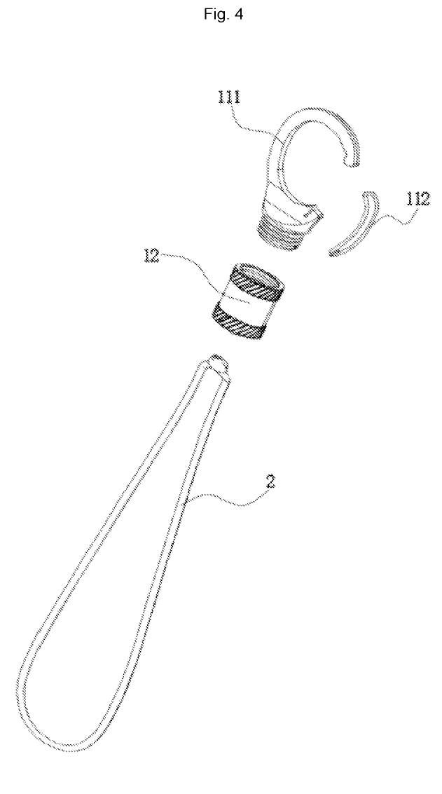

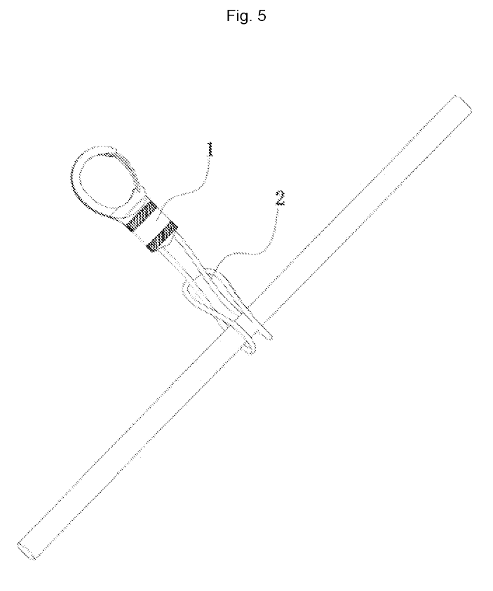

As shown in FIGS. 1-5, Embodiment 1 of a multi-purpose hanging buckle apparatus of the disclosure includes at least one hanging buckle group 1 and at least one flexible hanging rope 2, and the at least one flexible hanging rope 2 is sequentially connected with the at least one hanging buckle group 1 in a penetrating manner; and each of the at least one hanging buckle group 1 includes a hanging buckle body 11 with an opening and closing function and a connector 12, each of the at least one flexible hanging rope 2 is disposed on connector 12 of the at least one hanging buckle group 1 in a penetrating manner, and the connector 12 and the hanging buckle body 11 are detachably connected.

According to different applicable occasions and different demands of users, the number of the hanging buckle group 1 and the number of the flexible hanging rope 2 are selected, and they are flexibly connected and combined to obtain different hanging buckle apparatuses; for example, through combination of a plurality of hanging buckle groups 1 and one flexible hanging rope 2, the hanging buckle apparatus can have a plurality of hanging and buckling points; for example, through combination of one hanging buckle group 1 and a plurality of flexible hanging ropes 2, the hanging buckle apparatus can have a plurality of hanging points; still for example, through combination of a plurality of hanging buckle groups 1 and a plurality of flexible hanging ropes 2, the hanging buckle apparatus can have a plurality of hanging and buckling points and a plurality of hanging points at the same time; and random selection is carried out according to demands of users, and the use is extremely convenient. On one hand, the flexible hanging rope 2 is configured for connecting the plurality of hanging buckle groups 1 in a penetrating manner, on the other hand, the flexible hanging rope 2 directly acts on a hung article for being connected with the hung article, and the hanging buckle group 1 serves as the other end of the hanging buckle apparatus for fixing to hang the hung article to a place. Specifically, the hanging buckle body 11 with an opening and closing function is easily hung and fixed, the connector 12 serving as connection and transition of the hanging buckle body 11 and the flexible hanging rope 2 is configured to connect the flexible hanging rope 2 and also is detachably connected with the hanging buckle body 11, with the detachable connection mode, the flexible hanging rope 2 is conveniently replaced, and thus the service life of the hanging buckle apparatus is prolonged.

In the embodiment, one hanging buckle group 1 is available, and one flexible hanging rope 2 is available.

The hanging buckle body 11 includes a fixed part 111 and a movable part 112, the fixed part 111 is of a hollow structure with an opening, the movable part 112 blocks the opening, one end of the movable part 112 is hinged with one end of the opening of the fixed part 111, an other end of the movable part 112 is abutted to or clamped with an other end of the opening of the fixed part 111, the fixed part 111 is further in threaded connection with the connector 12, and the movable part 112 is rotated to enable the opening to be opened or closed.

The fixed part 111 is configured to bear pull force of hanging and connect the hanging buckle apparatus with outside, so as to realize the hanging function of the hanging buckle apparatus; the movable part 112 is configured to control the opening, by controlling the opening and closing of the opening of the hanging buckle body 11, the opening is open when the hanging buckle body 11 needs to realize hanging or release hanging with outside, and the purpose is realized; and in a normal hanging process, the opening is closed to avoid separation of the hanging buckle body 11, so that the hanging reliability of the hanging buckle body 11 is improved. Specifically, through hinging of the movable part 112 with the fixed part 111, when the movable part 112 is pressed, the movable part 112 rotates relative to the fixed part 111, so that the opening is opened or closed. The fixed part 111 is in threaded connection with the connector 12, so that the fixed part 111 is conveniently detached from the connector 12, and then assembly and disassembly of the flexible hanging rope 2 are facilitated.

As an improved solution of the embodiment, the movable part 112 has a through hole 1121 with a variable cross section, an end part of the fixed part 111 is provided with a clamping block 1111, and the clamping block 1111 is clamped with the through hole 1121.

The through hole 1121 with a variable cross section refers to that cross-sectional areas of the through hole 1121 are different at different positions. In some embodiments, the cross-sectional area, of the end where the movable part 112 is close to the clamping block 1111, of the through hole 1121 is large, and the cross-sectional area, of the end where the movable part 112 is away from the clamping block 1111, of the through hole 1121 is small; and therefore, after the clamping block 1111 is clamped with the through hole 1121, the possibility that the clamping block 1111 separates from the through hole 1121 non-artificially is reduced. Of course, within the cognition range of those skilled in the art, the through hole 1121 can also be a through hole 1121 with a fixed cross section.

Meanwhile, the connector 12 has at least one threading hole 121 for the flexible hanging rope 2 to pass through. Furthermore, two threading holes 121 are available, and the flexible hanging rope 2 is disposed in a manner of passing through the two threading holes 121 respectively.

Two ends of the flexible hanging rope 2 are respectively placed on the side, connected with the hanging buckle body 11, of the connector 12, two ends of the flexible hanging rope 2 are knotted, furthermore, the flexible hanging rope 2 can also be sintered to improve reliability of connection, so that the flexible hanging rope 2 is stably connected with the connector 12 in a penetrating manner, and meanwhile, when the flexible hanging rope 2 is connected with a hung article, fall and separation from the connector 12 due to force can also be avoided; when the flexible hanging rope 2 needs to be replaced, the knotting position is untied or sheared off, in such a case, the flexible hanging rope is pulled out from the other side of the threading hole; and the part of the flexible hanging rope 2 located on the other side of the connector forms a closed structure together with the connector, ( that is to say, the part of the flexible hanging rope 2 on the other side of the connector 12 is filled into the through hole 121 of the connector 12, thereby forming a closed structure together with the connector 12 ) so that the flexible hanging rope 2 is conveniently connected with the hung article. Of course, according to needs of use, if the flexible hanging rope 2 at the free end is more suitable for connection of the hung article, the positions of the flexible hanging rope 2 and the connector 12 can also be adjusted, so that two free ends of the flexible hanging rope are located on a side of the connector away from the hanging buckle body, the part of the flexible hanging rope 2 located on one side of the connector close to the hanging fastener body forms a closed structure together with the connector, ( that is to say, the part of the flexible hanging rope 2 on one side of the connector 12 close to the hanging buckle body 11 is filled into the through hole 121 of the connector 12, thereby forming a closed structure together with the connector 12 ) in such a case, two free ends of the flexible hanging rope 2 are utilized to be connected with the hung article, but the connection reliability of the flexible hanging rope 2 and the hung article needs to be ensured to ensure the reliability of the whole hanging buckle apparatus.

### Embodiment 2

The embodiment is Embodiment 2 of a multi-purpose hanging buckle apparatus, similar to Embodiment 1, in the embodiment, one hanging buckle group 1 is available, and 2-6 flexible hanging ropes are available.

The plurality of flexible hanging ropes 2 are connected with the same hanging buckle group 1 in a penetrating manner, the hanging buckle group 1 is utilized for hanging with outside, the flexible hanging rope 2 is utilized for connection with the hung article, it is that one flexible hanging rope 2 is adopted for hanging one article, or a plurality of flexible hanging ropes 2 are utilized to act on the same article together, so that the function of the hanging buckle apparatus is realized.

In the embodiment, one end of the flexible hanging rope 2 passes through the threading hole 121 and is knotted, the flexible hanging rope 2 is connected and fastened with the connector 12, the other end of the flexible hanging rope 2 is a free end, and the free end is utilized to connect the hung article.

### Embodiment 3

The embodiment is Embodiment 3 of a multi-purpose hanging buckle apparatus, similar to Embodiment 2, in the embodiment, after the flexible hanging rope 2 is connected with the hanging buckle group 1 in a penetrating manner, a blocking structure is formed between the flexible hanging rope 2 and the hanging buckle group 1.

In the embodiment, two end parts of the flexible hanging rope 2 are both located between the hanging buckle body 11 and the connector 12, by connecting two end parts of the flexible hanging rope 2, the reliability of penetration connection of the flexible hanging rope 2 and the connector 12 is promoted.

### Embodiment 4

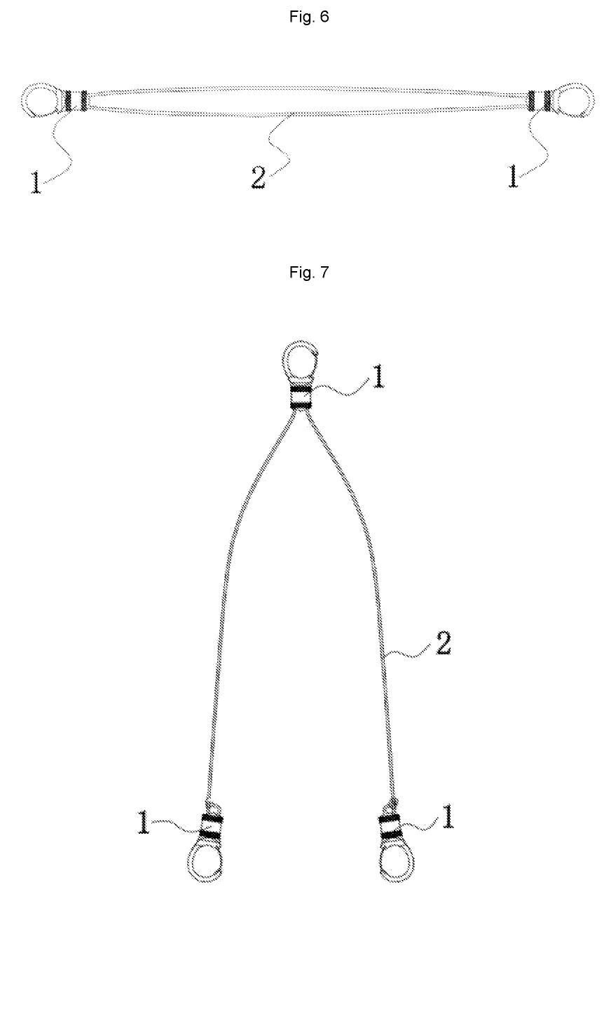

FIG. 6 illustrates Embodiment 4 of a multi-purpose hanging buckle apparatus of the disclosure, similar to Embodiment 1, in the embodiment, two hanging buckle groups 1 are available,1-6 flexible hanging ropes 2 are available, and the two hanging buckle groups 1 are respectively located at two ends of the 1-6 flexible hanging ropes 2.

Two hanging buckle groups 1 are disposed at two ends, the hanging buckle groups 1 at two ends are utilized for hanging with outside, so that a structure similar to a clothesline is formed, and the hung article is connected in the middle of the flexible hanging rope 2.

### Embodiment 5

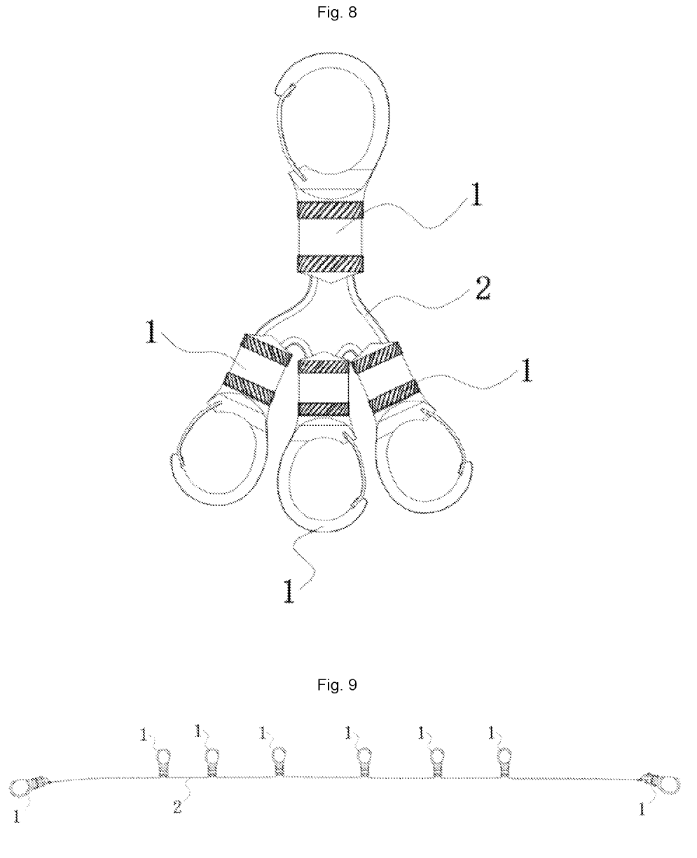

FIGS. 7-9 illustrate Embodiment 5 of a multi-purpose hanging buckle apparatus of the disclosure, similar to Embodiment 1, in the embodiment, at least three hanging buckle groups 1 are available, and 1-6 flexible hanging ropes 2 are available.

One flexible hanging rope 2 is used for connecting each hanging buckle group 1 in a penetrating manner, the length of the flexible hanging rope 2 is correspondingly selected according to needs, and the hanging buckle group 1 is configured for hanging with outside, and also is configured for hanging with the hung article. Or a plurality of flexible hanging ropes 2 are used for sequential penetration connection with each hanging buckle group 1, so that the strength of the whole hanging buckle apparatus is improved.

It is apparent the above-described embodiments of the disclosure are merely examples made for clearly illustrating the disclosure and are not limiting of the implementation modes of the disclosure. For those of ordinary skill in the art, other variations or modifications in different forms is made in light of the above description. It is not necessary and impossible to provide all the implementation modes here. Any modifications, equivalent replacements, improvements and the like made within the spirit and principle of the disclosure shall fall within the scope of protection of claims of the disclosure.

1. A multi-purpose hanging buckle apparatus, comprising at least one hanging buckle group and at least one flexible hanging rope, and the at least one flexible hanging rope is sequentially connected with the at least one hanging buckle group in a penetrating manner; each of the at least one hanging buckle group comprises a hanging buckle body with an opening and closing function and a connector, each of the at least one flexible hanging rope is disposed on connector of the at least one hanging buckle group in a penetrating manner, and the connector and the hanging buckle body are detachably connected.

2. The multi-purpose hanging buckle apparatus as claimed in claim 1, wherein the hanging buckle body comprises a fixed part and a movable part, the fixed part is of a hollow structure with an opening, the movable part blocks the opening, one end of the movable part is hinged with one end of the opening of the fixed part, an other end of the movable part is abutted to or clamped with an other end of the opening of the fixed part, the fixed part is further in threaded connection with the connector, and the movable part is rotated to open or close the opening.

3. The multi-purpose hanging buckle apparatus as claimed in claim 2, wherein the movable part has a through hole with a variable cross section, an end part of the fixed part is provided with a clamping block, and the clamping block is clamped with the through hole.

4. The multi-purpose hanging buckle apparatus as claimed in claim 1, wherein the connector has at least one threading hole for the flexible hanging rope to pass through.

5. The multi-purpose hanging buckle apparatus as claimed in claim 4, wherein two threading holes are available, and the flexible hanging rope is disposed in a manner of passing through the two threading holes respectively.

6. The multi-purpose hanging buckle apparatus as claimed in claim 1, wherein one hanging buckle group is available, and one flexible hanging rope is available.

7. The multi-purpose hanging buckle apparatus as claimed in claim 1, wherein one hanging buckle group is available, and 2-6 flexible hanging ropes are available.

8. The multi-purpose hanging buckle apparatus as claimed in claim 1, wherein two hanging buckle groups are available, 1-6 flexible hanging ropes are available, and the two hanging buckle groups are respectively located at two ends of the 1-6 flexible hanging ropes.

9. The multi-purpose hanging buckle apparatus as claimed in claim 1, wherein at least three hanging buckle groups are available, and 1-6 flexible hanging ropes are available.

10. The multi-purpose hanging buckle apparatus as claimed in claim 6, wherein after penetration connection with the hanging buckle group, the flexible hanging rope is formed a closed structure with the hanging buckle group.

11. The multi-purpose hanging buckle apparatus as claimed in claim 2, wherein the connector has at least one threading hole for the flexible hanging rope to pass through.

12. The multi-purpose hanging buckle apparatus as claimed in claim 3, wherein the connector has at least one threading hole for the flexible hanging rope to pass through.

13. The multi-purpose hanging buckle apparatus as claimed in claim 11, wherein two threading holes are available, and the flexible hanging rope is disposed in a manner of passing through the two threading holes respectively.

14. The multi-purpose hanging buckle apparatus as claimed in claim 12, wherein two threading holes are available, and the flexible hanging rope is disposed in a manner of passing through the two threading holes respectively.

15. The multi-purpose hanging buckle apparatus as claimed in claim 7, wherein after penetration connection with the hanging buckle group, the flexible hanging rope is formed a closed structure with the hanging buckle group.

16. The multi-purpose hanging buckle apparatus as claimed in claim 8, wherein after penetration connection with the hanging buckle group, the flexible hanging rope is formed a closed structure with the hanging buckle group.

17. The multi-purpose hanging buckle apparatus as claimed in claim 9, wherein after penetration connection with the hanging buckle group, the flexible hanging rope is formed a closed structure with the hanging buckle group.
